(19) United States
(12) Patent Application Publication
(10) Pub. No.: US 2023/0408291 A1
(43) Pub. Date: Dec. 21, 2023

(54) METHOD AND SYSTEM FOR IDENTIFYING SUITABLE ZONES FOR AUTONOMOUS VEHICLE OPERATION

(71) Applicant: Micropply Limited, Altrincham Cheshire (GB)

(72) Inventor: Anthony David George Rhoades, Altrincham Cheshire (GB)

(21) Appl. No.: 18/032,241

(22) PCT Filed: Oct. 15, 2021
(86) PCT No.: PCT/GB2021/052672

§ 371 Date: Apr. 17, 2023

(30) Foreign Application Priority Data
Oct. 16, 2020 (GB) 2016415.8

(51) Int. Cl. G01C 21/00; G05D 1/02; G05D 1/00; G06V 20/17; G06V 10/764; G06V 10/143; G06V 20/13

(52) U.S. Cl. CPC G01C 21/3826; G05D 1/0274; G01C 21/3852; G05D 1/0044; G06V 20/17; G06V 10/764; G06V 10/143; G06V 20/13; B64U 2101/30

(57) ABSTRACT

A method and system for identifying suitable zones for autonomous vehicle operation in a geographical area. The method and system includes receiving geographical data associated with the geographical area and processing the geographical data to determine area characteristics. The method and system further includes receiving vehicle data associated with said autonomous vehicle operation and comparing the area characteristics with the vehicle data and determining a suitable zone in the geographical area for said autonomous vehicle to operate.

The present invention relates to a method and system for identifying suitable zones for autonomous vehicle operation.

### BACKGROUND

Autonomous vehicles (AVs) may include self-driving vehicles and robots.

Self-driving vehicles may also be known as connected and autonomous vehicles, driverless vehicles, robo-vehicles and robotic vehicles. Such vehicles are defined as being capable of sensing its environment and moving safely with little or no human input.

Autonomous Vehicles may be completely autonomous (i.e. free from human operation and/or supervision) or may require at least partial human operation and/or supervision depending on the application.

Autonomous vehicles typically use a number of sensors to perceive their surroundings, such as radar, lidar, sonar, GPS, odometry and inertial measurement devices. Control systems interpret sensory information to identify appropriate navigation paths, as well as obstacles and relevant signage.

Known autonomous vehicles may include, for example, cars, trucks and buses for transportation of people and goods. Known autonomous vehicles may also include robotic vehicles such as, for example, Unmanned Ground Vehicles (UGV) and Unmanned Aerial Vehicles (UAV). Known autonomous vehicles also include Connected Autonomous Vehicles (CAV) which are capable of communicating with each other and which are connected to an edge device or cloud.

UGVs and UAVs are vehicles that operate while in contact with the ground or in the air, respectively, and without an onboard human presence. UGVs and UAVs are used for many different applications where it may be inefficient, inconvenient, dangerous or impossible to have a human operator present or, for example, where it may be more efficient, accurate or inexpensive to use a UGV or UAV.

Use of known autonomous vehicles has typically been restricted to known areas or zones, such as, for example, roadways, where the ground surface is very predictable.

Methods and systems are also known for determining optimal routes for autonomous vehicles to, for example, deliver goods from a fulfilment centre to a delivery address. Such methods and systems determine the optimal route to take for a specific delivering autonomous vehicles between known start and finish locations such as to avoid problematic obstacles, such as kerbs.

An example of such a method and system is disclosed in patent document US10,248,12061, assigned to Amazon Technologies Inc., wherein navigable path networks are defined based on attributes of delivery tasks to be performed by autonomous vehicles traveling thereon, based on attributes of such vehicles, or attributes of the environments in which such networks are provided. The networks include traditional and non-traditional transportation feature and are defined based on prior travel within the environments, including information gathered by such vehicles during such prior travel. The autonomous vehicles are robotic, self-powered units having storage compartments for carrying objects between points of the networks. An optimal route within a navigable path network is selected based on attributes of an autonomous vehicle, a task to be performed by the autonomous vehicle, or the various paths within the network. A navigable path network is updated based on information subsequently learned regarding the environment, including information captured by autonomous vehicles traveling on paths of the network.

However, problems exist in that autonomous vehicles have a wide range of possible applications in unknown environments in which the operating zone may be unknown and/or unpredictable. Also, suitable operating zones need to be identified to utilise specific autonomous vehicles designed to operate in and commercially exploit specific types of operating zone.

### SUMMARY OF INVENTION

According to a first aspect of the present invention, there is provided a method for identifying suitable zones for autonomous vehicle operation in a geographical area, the method comprising: receiving geographical data associated with said geographical area; processing the geographical data to determine an area characteristic; wherein the area characteristic comprises at least one of surface material, gradient, planarity, obstacles, geographical orientation, altitude, topography, population movement, travel networks and routes, size, shape and dimension; classifying the area characteristic into one or more suitable zone utility groups; receiving vehicle data associated with operation of at least one autonomous vehicle operation; determining autonomous vehicle utility based on the received autonomous vehicle data; comparing the suitable zone utility groups with the autonomous vehicle utility of the, or each, said autonomous vehicle and determining a suitable zone in said geographical area for the, or each, said autonomous vehicle to operate; providing a user interface comprising a map; and, communicating the determined suitable zone in said geographical area for said autonomous vehicle to operate to the user interface for displaying on the map.

The zone may be a surface. Alternatively, or additionally, the zone may be a three-dimensional space.

The topographical data may be mapping data or satellite data imported from a third-party entity, such as for example, Google® Maps and Apple® Maps. Google® Maps and Apple® Maps are examples of web mapping services which offer satellite imagery, aerial photography, 360° interactive panoramic views of streets, real time traffic conditions and route planning.

The topographical data is processed to determine the area characteristic. The area characteristic includes, for example, one or more of the surface material, gradients, planarity, obstacles, geographical orientation, ownership, value size, shape and dimension.

The at least one of surface material, gradients, planarity, obstacles, geographical orientation, size, shape and dimension may be determined by image analysis of the mapping/satellite data of the geographical area and compared to a standardised list of pre-analysed surface images. Localised geological and ground/street view data may be used to improve accuracy in determination of the surface material, gradients, planarity, obstacles, geographical orientation, size, shape and dimension. Time of day analysis may be used to improve accuracy in determination of the gradients, planarity and geographical orientation, which may include analysis of shadow orientation caused by sunlight at predetermined times of day.

Ownership and value of geographical surface areas is important to evaluate and determine as licenses may be required to operate autonomous vehicles on, or above, specific surface areas, especially on, for example, private land or for example, a roof of a building. Land registry data can be imported for evaluation and providing an overlay mapping data or satellite data.

Autonomous vehicle data associated with operating environments of an autonomous vehicle is imported and compared to the geographical data to determine a suitable zone in the geographical area for the autonomous vehicle to operate. Accordingly, suitable zones in geographical areas for specific autonomous vehicles to operate is provided.

Additionally, or alternatively, the topographical data is derived from aerial data collected from one or more data collection unmanned aerial vehicles, UAVs. The data collection UAV may have a LIDAR device and multispectral cameras for capturing aerial data.

The captured aerial data is then processed by a photogrammetry system to provide the topographical data, as discussed above.

A further embodiment may include a combination of mapping and/or satellite data and data collected from the data collection UAV.

The method advantageously further comprises sorting the identified suitable zones into utility zone groups relative to the operation of each autonomous vehicle.

The method may further advantageously comprise classifying the area characteristic of the identified suitable surfaces in respect of each utility group.

The method advantageously further comprises generating a utility zone look-up table and an autonomous vehicle utility look up table and comparing the utility zone look-up table and autonomous vehicle utility look-up table to determine a suitable match between a suitable zone and a suitable autonomous vehicle.

The utility zone look-up table may be generated from the list of area characteristics and may have a column comprising at least one of surface material, gradient; planarity, obstacles, geographical orientation, altitude, population density, population demographic, consumer population, consumer demographic, population movement, consumer movement, travel networks and routes, ownership, value, size, shape and dimension.

The autonomous vehicle utility-look up table may be generated from vehicle specifications and may have a column comprising at least one of wheel or track dimension, traction, motor power, motor torque, power range, payload, surface clearance, maximum speed, vehicle dimension, centre of gravity.

The suitable operating zones for the autonomous vehicle operation are advantageously displayed on a map through a graphical user interface (GUI).

The method may further comprise providing at least one autonomous vehicle. The autonomous vehicle may be an Unmanned Ground Vehicle (UGV) or an Unmanned Aerial Vehicle (UAV). The UGV and/or UAV may be a Connected Autonomous Vehicle (CAV).

As an example, the, or each, autonomous vehicle may be operable as a ground marking autonomous robotic vehicle.

An example of a ground marking robotic autonomous vehicle (AV) is a type equipped to deposit materials such as ink, paint or chemical treatment onto a ground surface. The ground marking robotic AV is a UGV equipped with a suite of artificial intelligence and machine learning algorithms for optimisation of any marking process whilst adapting in real-time to environmental factors, marking or printing constraints and image or marking accuracy feedback. The ground marking robotic AV creates ground-printed images having enhanced resolution and operated through an advanced user-interface (UI).

The ground-printed images may be, for example, company logos printed on sports grounds for advertising a company during an event, general advertising on identified suitable spaces to attract optimal large numbers of viewers, or road markings on highways, for efficient providing road markings with minimal disruption to traffic.

Where there are a plurality of ground marking autonomous vehicles, each vehicle has communications means operable to enable communication between each other. This enables the plurality of autonomous vehicles to work together to provide quicker and more efficient completion of a task, such as a printing task. In such an embodiment, the plurality of autonomous vehicles will communicate with each other through a peer-to-peer network.

Also, one or more of the autonomous vehicles may have system receiving means operable to receive operational information relating to the determined suitable surface in said geographical area for said autonomous vehicle to operate. The operational information may include, for example, the topographical data and real-time and forecasted weather conditions, such that the autonomous vehicle can automatically adjust its settings and determine power requirements to undertake the required task.

The method advantageously further comprises a user interface and communicating the determined suitable zone in said geographical area for said autonomous vehicle to operate to the user interface.

The user interface advantageously comprises a map and the determined suitable zones in said geographical area for said autonomous vehicle to operate is displayed on the map.

At least one of the area characteristic, and/or the utility zones are advantageously displayed on the map.

The, or each, autonomous vehicle is advantageously displayed on the map relative to the determined suitable zone for operation of the, or each, autonomous vehicle.

According to a second aspect of the present invention, there is provided a computer program product comprising a non-transitory readable medium holding computer program instructions, the computer program instructions executed by a hardware processor to carry out the method of the first aspect of the present invention.

According to a third aspect of the present invention, there is provided a system for identifying suitable zones for autonomous vehicle operation in a geographical area, the system comprising a communication network, and at least one autonomous vehicle, an edge communication device, a computer processor, wherein one or more of the at least one autonomous vehicles, the edge communication device and the computer processor are in communication with each other through the communication network, and the computer processor is operable to execute the computer program instructions of the second aspect of the present invention.

### BRIEF DESCRIPTION OF THE DRAWINGS

Embodiments of the invention will now be described by way of example and with reference to the following drawings, in which:

FIG. 1A is a diagram illustrating a method according to the present invention;

FIG. 1B is a diagram illustrating example of a look-up table according to the method of FIG. 1A

FIG. 2 is a schematic drawing of a side view of a Surface Marking Robot (SMR) for use with the method of FIG. 1A;

FIG. 3 is a schematic drawing showing a view from above of the SMR, of FIG. 2, in use; and

FIG. 4 is a schematic drawing of a system for implementing the method of FIG. 1A.

### DESCRIPTION

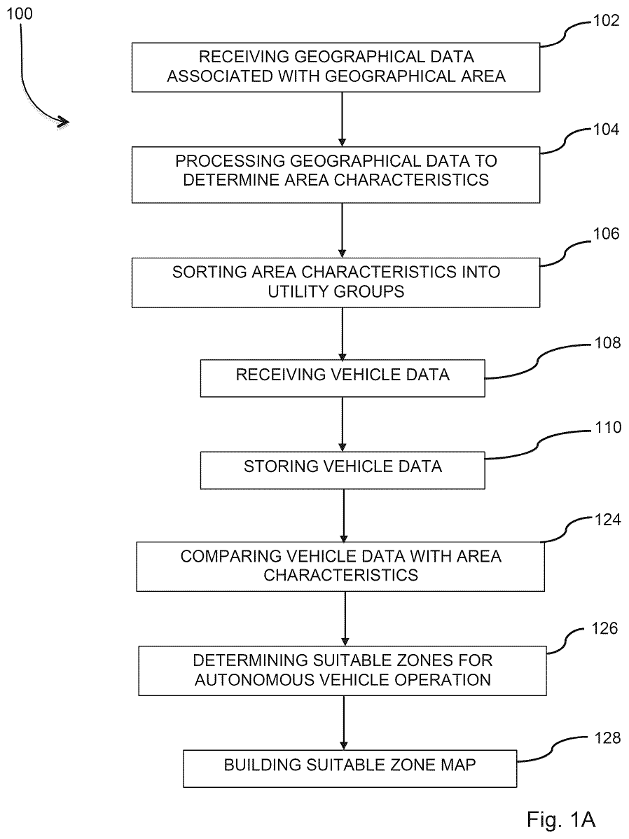

Referring to FIGS. 1A and 1B, a method 100 for identifying suitable zones for autonomous vehicle operation in a geographical area, according to the present Application, includes receiving geographical data associated with a geographical area 102.

Suitable zones include two-dimensional or three-dimensional areas or spaces, or a combination of the two. For example, a suitable zone may include a suitable surface on which an Unmanned Ground Vehicle (UGV) operates or an aerial space in which an Unmanned Aerial Vehicle (UAV) operates.

The geographical data may include one or more of, for example, topographical data, proprietary data and commercial data.

The topographical data includes for example, surface material, surface gradient, surface planarity, obstacles, geographical orientation of surface, surface altitude, size, shape and dimension. It may also include identification of specific common surfaces such as, for example, flat roofs, commercial buildings and municipal playing fields and the airspace above such surfaces.

The topographical data is derived from mapping data and/or satellite data imported digital image processing is used to process the mapping/satellite data. The mapping/satellite data may be imported from a third-party entity, such as for example, Google® Maps and Apple® Maps or other similar map/satellite data provider. Google® Maps and Apple® Maps are examples of web mapping services which offer satellite imagery, aerial photography, 360° interactive panoramic views of streets, real time traffic conditions and route planning.

In an alternative embodiment, the topographical data is derived from aerial data collected from one or more data collection unmanned aerial vehicles (UAV). The, or each, data collection UAV may include one or more LiDAR devices and multispectral cameras. The aerial data is processed using a photogrammetry system to provide the topographical data.

The proprietary data may include data indicative of the land or building or airspace ownership which may be derived from public databases such as, for example, The Land Registry in the United Kingdom. This data may also include the type, size and value of the land or building or airspace.

The commercial data may include any data which is indicative of a commercial value proposition of using a specific autonomous vehicle and/or an autonomous vehicle system in that specific geographical area. This may include, for example, one or more of: population density; population demographics; consumer population and demographic by type; population movement; consumer movement; and travel networks and routes, such as for example, passenger plane flight paths. Data relating to passenger plane flight paths may include, for example, number of flights, height of aeroplane, type of aeroplanes, and times of flights, at identifiable points or zones in the geographical area

The method further comprises processing the geographical data to determine one or more combined area characteristics 104. The combined area characteristic may be a unitary area characteristic, which represents two or more of the topographical data, proprietary data and the commercial data, or the area characteristic may include a topographical area characteristic, a proprietary area characteristic and a commercial area characteristic.

The method 100 preferably further comprises sorting the area characteristics into zone utility groups 106, based on the determined one or more combined area characteristics. The, or each, zone utility group is associated with possible operational requirements and/or limitations of autonomous vehicles and/or potential commercial opportunities. As an example, a zone utility group may be: an advertising utility zone group indicative of operational suitability for a Surface Marking Robot (SMR); a grass cutting utility zone group indicative of operational suitability for Grass Cutting Robots for use on, for example, golf courses; an agricultural utility zone group, indicative of operational suitability for UGVs or UAVs for use, for example, in fertilizing or crop spraying; a road surface utility zone group indicative of road surface and pot-hole repair robots; a solar array cleaning utility zone group indicative of operational suitability of solar array cleaning robots.

The method 100 further comprises receiving vehicle data associated with the operation and utility of specific autonomous vehicles 108 and storing the vehicle data on a database 110. The vehicle data may include, for example, one or more of the utility of the vehicle, the operating parameters or limitations of the vehicle, and the operating, hire or job costs which may be provided per square area (e.g. m 2).

The operating parameters or limitations of the specific autonomous vehicle may include, for example, wheel or track dimensions, traction, motor power, motor torque, power range, payload, surface clearance, maximum speed, vehicle dimension, centre of gravity. It will be appreciated that other operating parameters and limitations may be included, and any one or more may be excluded, depending on the specific application and utility of the autonomous vehicle.

Referring particularly to FIG. 1B, an autonomous vehicle (AV) utility look-up table 112 may be generated from an autonomous vehicle (AV) specification table 114 having lists including the technical operating parameters and limitations 116 of each autonomous vehicle.

A suitable zone utility look-up table 118 may be generated from an area characteristic look-up table 120. The area characteristic look-up table 120 may include zone-related listings 122 including, for example, any one or more of surface material, gradient, planarity, obstacles, geographical orientation, altitude, population density, population demographic, consumer population, consumer demographic, population movement, consumer movement, travel networks and routes, ownership, value, size, shape and dimension.

The suitable zone utility group look-up table 118 is indicative of the suitable utility for each zone. For example: grass cutting utility zone group indicative of operational suitability for Grass Cutting UGVs; advertising utility zone group and road surface utility group zone indicative as suitable for surface marking UGVs, agricultural utility zone group indicative as suitable for aerial crop spraying UAVs; road surface utility zone group indicative of road surface marking UGVs and pot-hole repair UGVs; a solar array cleaning utility zone group indicative of suitability for solar array cleaning UGVs.

Where one or more zones are determined to be suitable for more than one utility group, they may be classified as multi-utility group zones and presented accordingly. For example, a zone may be identified as suitable for advertising and a different zone may be identified as a road surface. Both the advertising zone and the road surface zone may be classified as suitable zones for operation of a surface marking UGV, for printing advertisements on, for example, the surface of a sports arena and printing markings on a road surface, respectively.

Referring to FIGS. 1A and 1B, the method 100 further comprises comparing the automated vehicle utility group look-up table 112 with the suitable zone utility group look-up table 118 for each geographical area 124 and determining suitable zones for the autonomous vehicle to operate 126.

Comparing the automated vehicle utility group look-up table 112 with the suitable zone utility group look-up table 118 thereby comprises matching suitable autonomous vehicles with suitable utility zones indicative of suitable zones in which the selected autonomous vehicles are operable.

Accordingly, a list of stored vehicle data is compared with the area characteristics for each geographical area to determine a suitable autonomous vehicle for operating or undertaking a job in a zone of a specified geographic area. Similarly, suitable geographical areas can be determined for utilising a specific autonomous vehicle.

The method 100 further comprises building a suitable zone map for the geographical area 128. Layers of information can be added to overlie a base layer map to provide visual information associated with the topographical data, proprietary data and the commercial data, as required. With regard to the passenger flight path data, flight paths of passenger planes can be tracked and built up on the map and represented as a heat map to show where and to quantify passenger movements relative to suitable zones. The suitable zone map has a zoom in/out function.

The suitable zone map is interactively presented to end users through a User Interface which is accessed through an end-to-end Cloud SAAS (Software As A Service). A suitable zone is selectable by a user on the suitable zone map and the selected suitable zone is assignable to the user's account. An autonomous vehicle is then assignable for use at the selected suitable zone to undertake the required activity.

Autonomous vehicles are specifically designed and specified to operate in specified environments and to travel on and over specified surfaces and in specified zones.

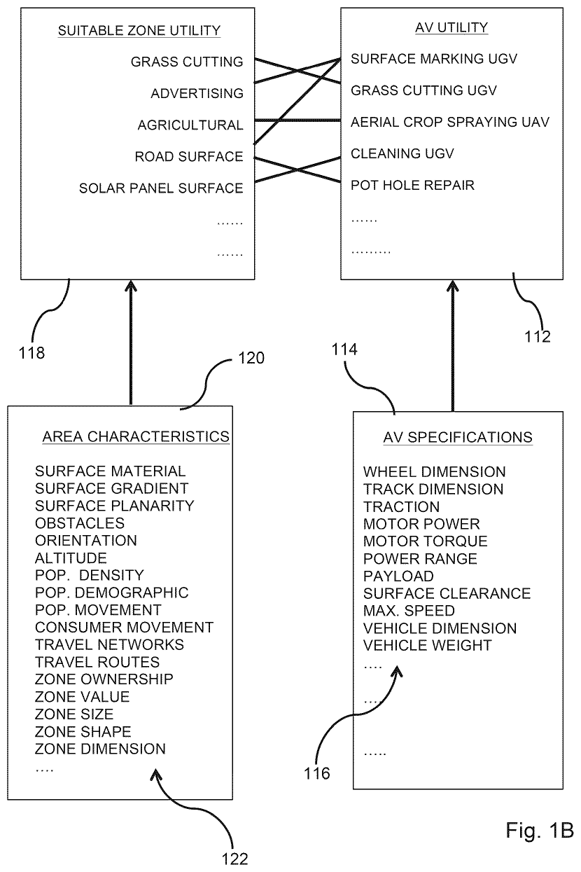

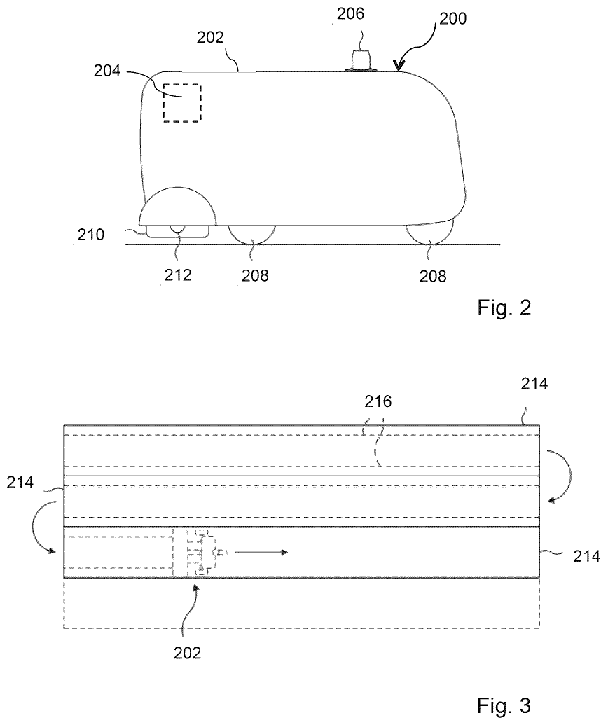

Referring also to FIGS. 2 and 3, an embodiment of the present invention may include an autonomous vehicle 200 such as, for example, a horizontal surface marking robot (SMR) 202. The SMR 202 is operable to print or deposit materials on specified non-vertical surfaces to provide, for example, ground-printed text and images. Such images may be, for example, advertisements on viewable surfaces, such as logos on surfaces of sport/event arenas or any non-vertical surface which may be viewed by the public such as, for example, a building rooftop viewable from a passenger aeroplane.

The SMR 202 has a communication module 204 for communicating with a remote resource such as the cloud. The cloud may comprise any suitable data processing device or embedded system which can be accessed from another platform such as a remote computer, content aggregator or cloud platform.

The SMR 202 also has a position sensor 206, which comprises a Global Positioning System (GPS) Device for navigation through satellite positioning or a local triangulation system. In use, the position sensor 206 is operable to position and reposition the SMR 202 to deposit/print material, as required.

The SMR 202 has a chassis supporting a ground wheel arrangement 208 and a print head 210 disposed on a traverse guide 212 and displaceable along the traverse guide 212 beyond the width of the wheel arrangement 208. The drawings only show two side wheels. However, it will be appreciated that the wheel arrangement may also include two other wheels on the opposing hidden side.

Referring to FIG. 3, the SMR 202 prints a strip 214 of image wider than the width of the ground wheel arrangement 208 and when a strip 214 of image has been printed the SMR 202 turns around to print an adjacent strip. In this way, the ground wheel arrangement 208 does not run over any part of the freshly painted ground. As can be seen in FIG. 3, the outer tracks 216 of the ground wheel arrangement 208 is well within the width of the strips 214. The SMR 202 is specifically designed and operable to deposit or print text and images from the print head onto specified non-vertical surfaces as the SMR 202 moves over the surface.

The SMR 202 has an operational specification which includes, for example, one or more of operating limitations such as, for example, surface material, gradient, planarity and altitude.

In order to utilise the SMR 202 it is necessary to identify surfaces within its operational specification and also identify surfaces which maximise the commercial utilisation of the autonomous vehicle.

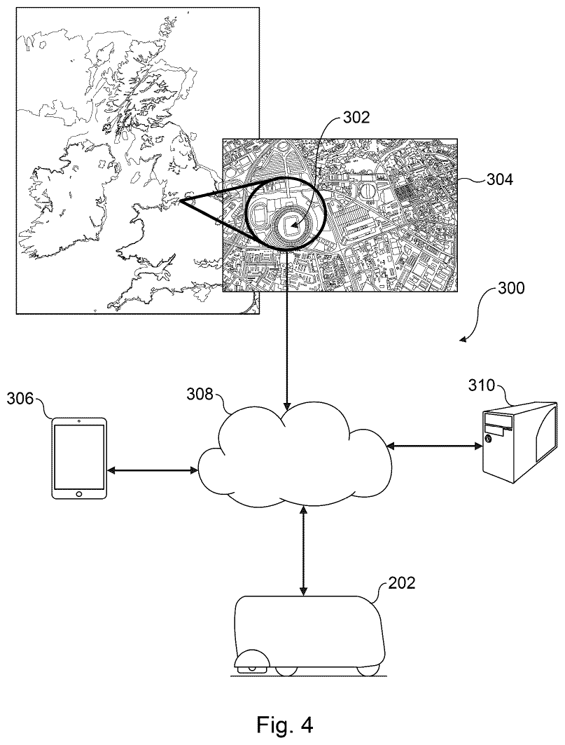

Referring also to FIG. 4, a system 300 for identifying suitable zones 302 for autonomous vehicle operation in a geographical area 304 includes an autonomous vehicle 200, such as the SMR 202, in communication with a remotely located edge device 306 through a communication network 308. The edge device 306 may be a computer, laptop, tablet or mobile phone. The communication network 308 may be a cloud-based communication network.

A computer processor 310 is also operable to communicate through the communication network 308 with the SMR 202 and the edge device 306.

The computer processor 310 stores computer program instructions which, when executed, carries out the method 100, as shown in FIGS. 1A and 1B. Upon execution of the computer program instructions, the computer processor 310 receives geographical data associated with the geographical area 304.

The geographical data may include one or more of, for example, topographical data, proprietary data and commercial data of surface areas.

The topographical data includes for example, surface material, surface gradient, surface planarity, geographical orientation of surface and surface altitude. It may also include identification of specific common surfaces such as, for example, flat roofs, commercial buildings and municipal playing fields.

The topographical data is derived from mapping data and/or satellite data.

The mapping/satellite data may be imported from a third-party entity, such as for example, Google® Maps and Apple® Maps or other similar map/satellite data provider. Google® Maps and Apple® Maps are examples of web mapping services which offer satellite imagery, aerial photography, 360° interactive panoramic views of streets, real time traffic conditions and route planning.

In an alternative embodiment (not shown in drawings), the topographical data is derived from aerial data collected from one or more unmanned aerial vehicles (UAV). The, or each, UAV may include one or more LiDAR devices and multispectral cameras. The aerial data is processed using a photogrammetry system to provide the topographical data as a map.

The proprietary data may include data indicative of the land or building ownership which may be derived from public databases such as, for example, The Land Registry in the United Kingdom. This data may also include the type, size and value of the land or building.

The commercial data may include any data which is indicative of a commercial value proposition of using a specific autonomous vehicle and/or an autonomous vehicle system on that specific geographical area. This may include, for example, one or more of: population density; population demographics; consumer population and demographic by type; population movement; consumer movement; and travel networks and routes, such as for example, passenger plane flight paths.

The geographical data is processed to determine one or more combined area characteristics. The combined area characteristic may be a unitary area characteristic, which represents two or more of the topographical data, proprietary data and the commercial data, or the area characteristic may include a topographical area characteristic, a proprietary area characteristic and a commercial area characteristic.

The identified suitable zones are sorted into utility groups 106, based on the determined one or more combined area characteristics. The, or each, utility group is associated with possible operational requirements and limitations of autonomous vehicles and/or potential commercial opportunities.

The computer processor 310 further receives vehicle data and commercial requirements, associated with the operation of one or more specific autonomous vehicles such as the SMR 202 and records the vehicle data on a database. The vehicle data may include, for example, one or more of the utility of the vehicle, the operating parameters or limitations of the vehicle, and the operating, hire or job costs which may be provided, for example, per square area (e.g. m 2).

The stored vehicle data is compared with the area characteristics for each geographical area to determine suitable zones for the autonomous vehicle (SMR 202) to operate

Alternatively, a list of stored vehicle data is compared with the area characteristics for each geographical area to determine a suitable autonomous vehicle for operating or undertaking a job on a zone of a specified geographic area.

The suitable zone utility groups of the geographical areas are compared and matched with the automated vehicle utility groups, as previously described with reference to FIGS. 1A and 1B.

Digital image processing is used to process the geographical data and the vehicle data. Artificial Intelligence and Machine Learning engines are used to improve the accuracy of identification of suitable zones and matching of the zones to the autonomous vehicle.

A suitable zone map is built off a base layer map for the geographical area. Layers of information can be added to overlie the base layer map to provide visual information associated with the topographical data, proprietary data and the commercial data, as required. With regard to the passenger flight path data, flight paths of passenger planes can be tracked and built up on the map and represented as a heat map to show where and to quantify passenger movements relative to suitable zones. The suitable zone map has a zoom in/out function.

The suitable zone map is presented to end users through a User Interface which is accessed through an end-to-end Cloud SAAS (Software As A service). In use, a user accesses the system through the edge device 306. For a specific autonomous vehicle, such as the SMR 202, a user can view the suitable zone map showing the most suitable zones on which to operate the vehicle in a geographical region, based on the autonomous vehicle specification and the commercial opportunity and cost. A user zooms in to a geographical region in which they are interested. Once the user has decided on a suitable zone, that suitable zone is selected on the suitable zone map and assigned to the user's account. An autonomous vehicle (e.g. SMR 202) is then assigned for use on the selected suitable zone. In the case of the SMR 202, the user can upload an image to the computer processor 310. The computer processor 310 processes the image and communicates the processed image to a SMR 202 for operating on the selected suitable surface to print the processed image thereon.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

As an example, a further clause of the present invention may be characterised by a method for identifying suitable zones for autonomous vehicle operation in a geographical area, the method comprising: receiving geographical data associated with said geographical area; processing the geographical data to determine area characteristics, wherein the area characteristic comprises at least one of surface material, gradient; planarity, obstacles, geographical orientation, altitude, population density, population demographic, consumer population, consumer demographic, population movement, consumer movement, travel networks and routes, ownership, value, size, shape and dimension; receiving vehicle data associated with said autonomous vehicle operation; comparing the area characteristic with the vehicle data and determining a suitable zone in said geographical area for said autonomous vehicle to operate.

1. A method for identifying suitable zones for autonomous vehicle operation in a geographical area, the method comprising:
receiving geographical data associated with said geographical area;
processing the geographical data to determine an area characteristic, wherein the area characteristic comprises at least one of surface material, gradient, planarity, obstacles, geographical orientation, altitude, topography, population movement, travel networks and routes, size, shape and dimension;
classifying the area characteristic into one or more suitable zone utility groups;
receiving vehicle data associated with operation of at least one autonomous vehicle operation;
determining autonomous vehicle utility based on the received autonomous vehicle data;
comparing the suitable zone utility groups with the autonomous vehicle utility of the, or each, said autonomous vehicle and determining a suitable zone in said geographical area for the, or each, said autonomous vehicle to operate;
providing a user interface comprising a map; and,
communicating the determined suitable zone in said geographical area for said autonomous vehicle to operate to the user interface for displaying on the map.

2. A method as claimed in claim 1, wherein the suitable zone is a surface.

3. A method as claimed in claim 1, wherein the suitable zone is a three-dimensional space.

4. A method as claimed in claim 1, wherein the geographical data is derived from at least one of mapping data and satellite data.

5. A method as claimed in claim 1, wherein the geographical data is derived from aerial data collected from one or more data collection unmanned aerial vehicles, UAV.

6. A method as claimed in claim 5, wherein the, or each, data collection UAV comprises a LiDAR device.

7. A method as claimed in claim 5, wherein the, or each, data collection UAV comprises multispectral cameras.

8. A method as claimed in claim 5, wherein the aerial data is processed using a photogrammetry system to provide the topographical data.

9. A method as claimed in claim 1, wherein receiving at least part of the geographical data comprises importing a topographical data set from a third-party entity.

10. A method as claimed in claim 1, further comprising generating a zone utility group look-up table and an autonomous vehicle utility look up table and comparing the zone utility group look-up table and autonomous vehicle utility look-up table to determine a suitable match between a suitable zone and a suitable autonomous vehicle.

11. A method as claimed in claim 10, wherein the autonomous vehicle utility-look up table is generated from a vehicle specifications table having a list comprising at least one of wheel or track dimension, traction, motor power, motor torque, power range, payload, surface clearance, vehicle speed, vehicle dimension and centre of gravity.

12. A method as claimed in claim 1, further comprising providing at least one of said autonomous vehicles.

13. A method as claimed in claim 12, wherein the, or each, autonomous vehicle is operable as a ground marking autonomous robotic vehicle.

14. A method as claimed in claim 12, comprising providing a plurality of autonomous vehicles and providing communications means operable to enable communication between the plurality of autonomous vehicles.

15. A method as claimed in claim 12, further comprising communicating to the, or each, autonomous vehicle information relating to the determined suitable zone in said geographical area for said autonomous vehicle to operate.

16. A method as claimed in claim 1, wherein one or more of the area characteristics, and/or the utility zone is displayed on the map.

17. A method as claimed in claim 1, wherein the, or each, autonomous vehicle is displayed on the map relative to the determined suitable zone for operation of the, or each, autonomous vehicle.

18. A method as claimed in claim 1, further comprising providing a user utility interface operable to present the determined suitable zone in said geographical areas for said autonomous vehicle to operate to an interested party, and receiving an instruction to deploy an autonomous vehicle.

19. A computer program product comprising a non-transitory readable medium holding computer program instructions, the computer program instructions executed by a hardware processor to carry out the method of claim 1.

20. A system for identifying suitable zones for autonomous vehicle operation in a geographical area, the system comprising:
a communication network;
an autonomous vehicle;
an edge communication device;
a computer processor;
wherein the autonomous vehicle, the edge communication device and the computer processor are in communication with each other through the communication network, and the computer processor is operable to execute the computer program instructions of claim 19.
